(19) United States
(12) Patent Application Publication
(10) Pub. No.: US 2015/0084980 A1
(43) Pub. Date: Mar. 26, 2015

(54) CONSTRAINED COLOR PALETTE FOR MULTI-PRIMARY DISPLAY DEVICES

(71) Applicant: QUALCOMM Mems Technologies, Inc., San Diego, CA (US)

(72) Inventors: Huanzhao Zeng, Vancouver, WA (US); Jian J. Ma, Carlsbad, CA (US)

(73) Assignee: QUALCOMM Mems Technologies, Inc., San Diego, CA (US)

(21) Appl. No.: 14/036,314

(22) Filed: Sep. 25, 2013

(51) Int. Cl. G09G 5/06

(52) U.S. Cl. CPC G09G 5/06
USPC 345/601

(57) ABSTRACT

This disclosure provides systems, methods and apparatus, including computer programs encoded on computer storage media, for displaying high bit-depth images using temporal modulation on display devices including display elements that have multiple primary colors. In order to reduce visual artifacts produced by angular metamerism, the display elements are configured to display only those combinations of the different primary colors that satisfy certain constraints. Color combinations of the multiple primary colors that satisfy these constraints are included in a constrained color palette that includes fewer than all the possible colors that can be provided by all combinations of the primary colors.

### TECHNICAL FIELD

This disclosure relates to methods and systems for selecting a color palette for temporal modulation in displays and more particularly to electromechanical systems displays and projection and printing devices having multiple primary colors.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Some display devices, such as, for example EMS systems based display devices, can produce an input color by utilizing more than three primary colors. Each of the primary colors can have reflectance or transmittance characteristics that are independent of each other. Such devices can be referred to as multi-primary display devices. In multi-primary display devices there may be more than one combination of the multiple primary colors to produce the same color having input color values, such as red (R), green (G), and blue (B) values.

### SUMMARY

The systems, methods and devices of this disclosure each have several innovative aspects, no single one of which is solely responsible for the desirable attributes disclosed herein.

One innovative aspect of the subject matter described in this disclosure can be implemented in a computer-implemented method to generate a color palette for temporal modulation in digital imaging. The method can be performed under the control of a hardware computing device. The method comprises identifying a set of M primary colors that can be produced by a display element, the set of primary colors including black and white color primaries and M minus 2 non-white and non-black color primaries, wherein M has a value that is equal to at least 6. The method further comprises generating a color palette that includes color combinations produced by selecting N primary colors from the identified set of M primary colors, wherein N represents a number of sub-frames for temporal modulation. In various implementations N is less than M. The method further comprises generating a constrained color palette from the color palette by analyzing each color combination in the color palette and adding a respective color combination to the constrained color palette if each non-white and non-black color primary in the respective color combination, is within a neighborhood of each other non-white and non-black color primary in the respective color combination. The constrained color palette can be provided for use in a temporal modulation scheme.

In various implementations, all color combinations including only black and white color primaries can be added to the constrained color palette. In various implementations, the colors in the color palette can be indexed by a sequence value, and for two non-white and non-black color primaries C_{I} and C_{J} in the respective color combination with index sequence values I and J, the two non-white and non-black color primaries C_{I} and C_{J} can be within the neighborhood of each other if the difference between I and J is less than or equal to a neighbor value D, where the neighbor value D is a size of the neighborhood around the non-white and non-black color primary C_{I}. In various implementations, the neighbor value D can have a value between 0 and 4. In various implementations, the two non-white and non-black color primaries in the respective color combination can be within the neighborhood of each other if a distance between the two non-white and non-black color primaries in a color space is less than a threshold distance in the color space. In various implementations, the set of primary colors includes at least four (4) primary colors. In various implementations, the display element can include an interferometric modulator, and the N primary colors can be from at least one interferometric order. In various implementations, the N primary colors can be from the same interferometric order.

In various implementations, a device comprising a display can be configured to display an image data with a temporal modulation scheme using the constrained color palette generated by the above described method. Various implementations of the display can include one or more display elements, a processor that is configured to communicate with the display and a non-transitory memory device that is configured to communicate with the processor. In various implementations, the processor can be configured to process image data. In various implementations, the display can be a reflective display device. In various implementations, the display element can include a movable mirror. In various implementations, the display element can be configured to display a color in a color space associated with the display wherein the displayed color depends on a position of the movable mirror.

Another innovative aspect of the subject matter described in this disclosure can be implemented as a non-transitory computer storage medium comprising instructions that when executed by a processor cause the processor to perform a method to generate a color palette for temporal modulation in digital imaging. The method can be any of the methods described herein. For example, one implementation of the method comprises identifying a set of M primary colors that can be produced by a display element, the set of primary colors including black and white color primaries and M minus 2 non-white and non-black color primaries, wherein M has a value that is equal to at least 6. The method further comprises generating a color palette that includes color combinations produced by selecting N primary colors from the identified set of M primary colors, wherein N represents a number of sub-frames for temporal modulation. In various implementations N is less than M. The method further comprises generating a constrained color palette from the color palette by analyzing each color combination in the color palette and adding a respective color combination to the constrained color palette if each non-white and non-black color primary in the respective color combination, is within a neighborhood of each other non-white and non-black color primary in the respective color combination. The constrained color palette can be provided for use in a temporal modulation scheme.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5 is a flow diagram illustrating a manufacturing process for an IMOD display or display element.

FIGS. 6A-6E are cross-sectional illustrations of various stages in a process of making an IMOD display or display element.

FIGS. 7A and 7B are schematic exploded partial perspective views of a portion of an electromechanical systems (EMS) package including an array of EMS elements and a backplate.

FIG. 8A shows a cross-section of an implementation of an analog IMOD (AIMOD). FIG. 8B is a color chart that illustrates examples of the various primary colors produced by an implementation of an AIMOD similar to the AIMOD depicted in FIG. 8A.

FIGS. 9A-1, 9A-2, and 9A-3 illustrate examples of different color levels that can be produced by temporal modulation with a white primary color and a black primary color using one, two or four temporal frames.

FIGS. 9B-1 and 9B-2 illustrate examples of different color levels that can be produced by temporal modulation with a white primary color, a black primary color, and a non-black and non-white primary color using one or two temporal frames.

FIG. 10A shows an example of a set of 128 primary colors produced by a multi-primary display device in the International Commission on Illumination (CIE) Luv color space.

FIG. 10B illustrates an example of producing a gray (X) color level by combining different primary colors and using temporal modulation with two temporal frames.

FIG. 11 illustrates an example of the color shift that may occur when a set of primary colors (for example, the 128 primary colors depicted in FIG. 10A) produced by a multi-primary display element is viewed along two different directions.

FIG. 12 illustrates an example of different color combinations of primary colors that can be excluded from a constrained color palette in order to reduce angular metamerism.

FIG. 13A is a flow chart that describes an implementation of a method of generating a constrained color palette by excluding combinations of different primary colors that do not satisfy certain constraints.

FIG. 13B is a flow chart that describes an implementation of a method of analyzing possible combinations of the different primary colors to generate a constrained color palette.

FIGS. 14A and 14B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The systems and methods described herein can be used to display high bit-depth color images (e.g., images having 8 bits per color channel) on a display device including a plurality of display elements having lower color bit-depth (for example, 1, 2 or 4 bits per color channel). Each display element of the display device can produce multiple primary colors in a color space associated with the display device. To display high bit-depth color images (for example, with 8 bits per color channel or 256 color levels per color channel) on a multi-primary display device, temporal modulation and/or spatial modulation can be used. For example, using temporal modulation with four temporal frames and black and white colors, five colors including three gray levels can be displayed. As another example, using temporal modulation with two temporal frames and black, white and a primary color (e.g., red, green or blue), six colors can be displayed. Many different color levels can be produced by including more primary colors and temporal frames.

Systems and methods described herein can produce a constrained color palette for temporal modulation. The constrained color palette includes only a subset of less than all the possible color combinations of the multiple primary colors produced by the multi-primary display device. Using the constrained color palette can more fully exploit the benefit of applying temporal modulation to display high resolution color images on low resolution display devices having multi-primary display elements. For a color that is represented by different combinations or white (W), black (K) and other non-white and non-black primary colors, those combinations are included in the constrained palette that have (i) the most black and white primary colors; and (ii) the other non-white and non-black primary colors within a neighborhood of each other.

For example, consider a color C0 that can be represented by two different combinations. The first combination includes a black primary (K), a white primary (W) and a non-white, non-black primary color P0. The second combination includes a first non-white, non-black primary color P1, a second non-white, non-black primary color P2, and a third non-white, non-black primary color P3. In this example, the first combination is included in the constrained color palette while the second combination is excluded from the constrained color palette.

As another example, consider a color C1 that can be represented by two different combinations. The first combination includes a first non-white, non-black primary color P4, a second non-white, non-black primary color P10, and a third non-white, non-black primary color P7. The primary colors P4, P7 and P10 being in a neighborhood of each other. The second combination includes a first non-white, non-black primary color P20, a second non-white, non-black primary color P13, and a third non-white, non-black primary color P8. The primary colors P8, P13 and P20 not being in a neighborhood of each other. In this example, the first combination is included in the constrained color palette while the second combination is excluded from the constrained color palette.

The constrained color palette can be generated by a hardware computer processor and stored in a non-transitory computer memory for use in various display devices including multi-primary display elements.

Particular implementations of the subject matter described in this disclosure can be implemented to realize one or more of the following potential advantages. It is possible to display high bit-depth digital images on display devices having low native bit-depth multiple primary colors to render intermediate tones that cannot be natively displayed by the display device. Angular metamerism can occur in some implementations of multi-primary display devices, when colors that appear the same in one viewing direction look different in another viewing angle. Angular metamerism can be problematic in color rendering on multi-primary display devices, because two colors that were initially metameric to each other (e.g., visually appear the same) may become visually distinct under a change of viewing angle. Because a color may be rendered by different combinations of the multiple primary colors, color shift of the multiple primary colors due to a change in the viewing angle can shift the rendered color differently based on the selected combination. Color shift from different combinations of multiple primary colors (metameric colors) may produce additional artifacts, such as contouring and banding. Use of the constrained color palette can advantageously reduce artifacts arising from angular metamerism. For example, the constrained color palette includes color combinations by mixing black and white colors. Since black and white primary colors exhibit lower angular metamerism as compared to other primary colors, those color combinations in the constrained palette that are combinations of black and white primary colors may be less susceptible to defects arising from angular metamerism. Furthermore, black and white colors may be more consistent than other primary colors in mass production of display devices. Therefore, it can be advantageous to use as much of black and white primaries as possible in color reproduction. As another example, color combinations that are produced by primary colors other than black and white that are within a neighborhood of each other may be less susceptible to defects arising from angular metamerism than color combination produced by primary colors other than black and white that are complementary or have very different hues. Thus, excluding such combinations from the constrained color palette may be advantageous to reduce angular metamerism. By constraining the color palette, a smaller color palette table can be generated which can advantageously reduce the memory requirement for temporal modulation. Also, due to the smaller number of colors in the constrained color palette, a number of primary color changes during temporal modulation can be reduced which may result in reducing power consumption.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

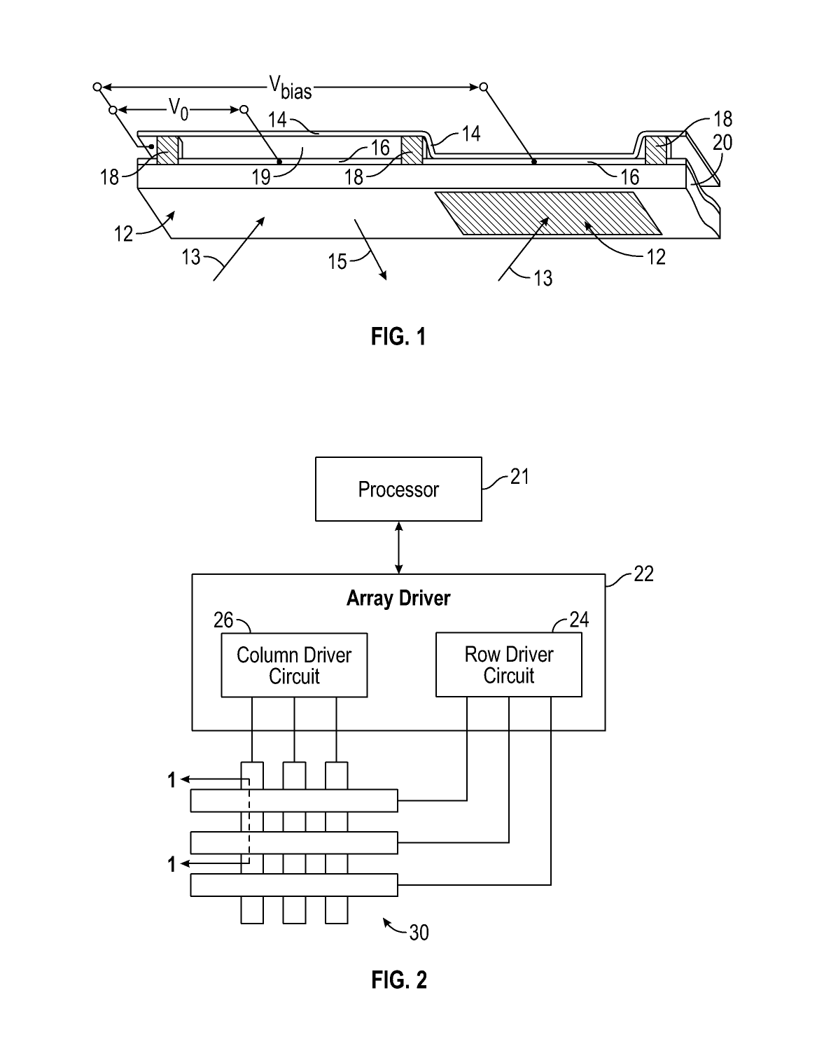

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

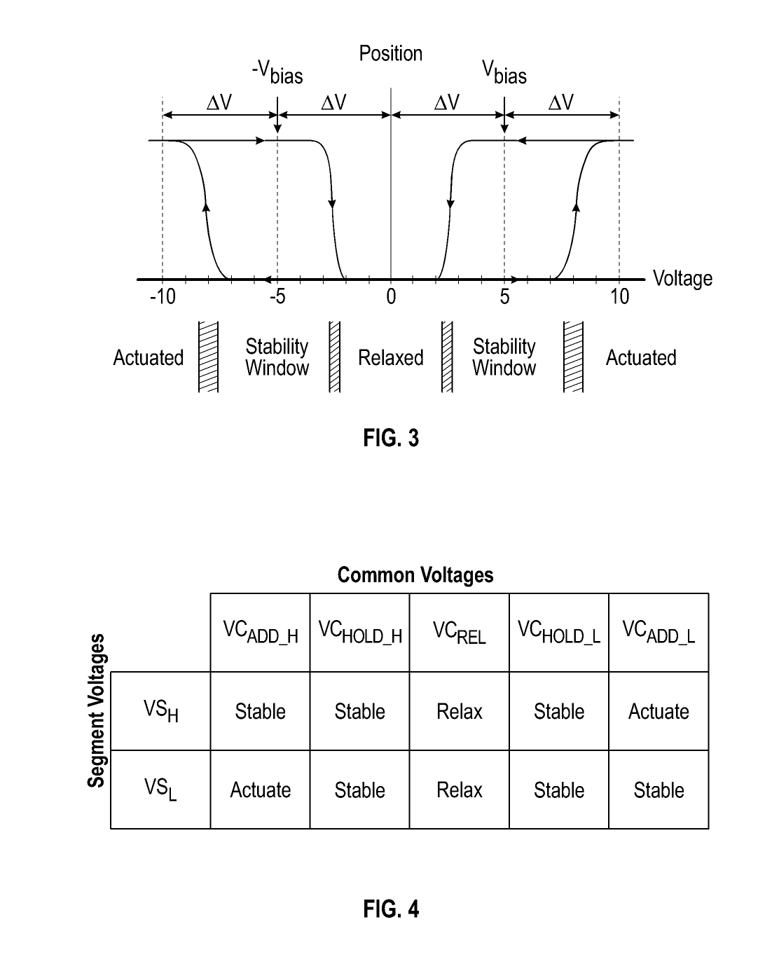

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

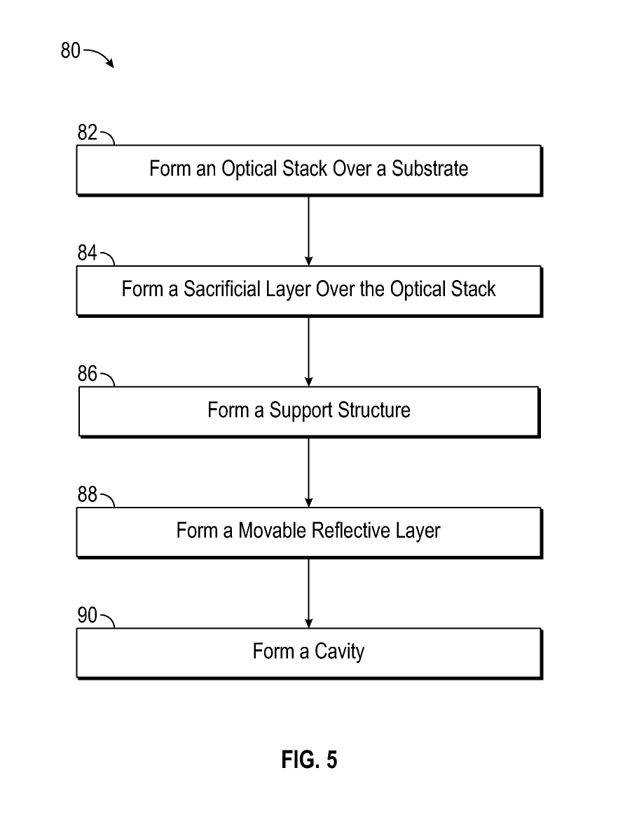

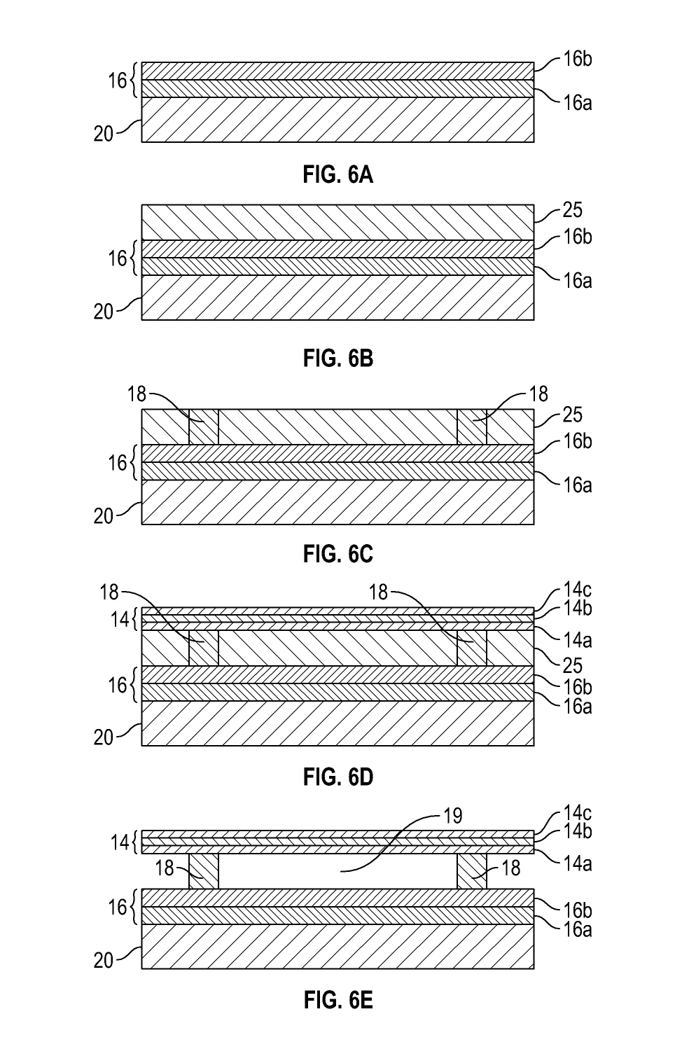

FIG. 5 is a flow diagram illustrating a manufacturing process 80 for an IMOD display or display element. FIGS. 6A-6E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 5. The process 80 begins at block 82 with the formation of the optical stack 16 over the substrate 20. FIG. 6A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 6A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 6A-6E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 6B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 6E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 6C, the aperture formed in the sacrificial layer 25 can extend through the sacrificial layer 25, but not through the optical stack 16. For example, FIG. 6E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 6C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 6D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 6D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

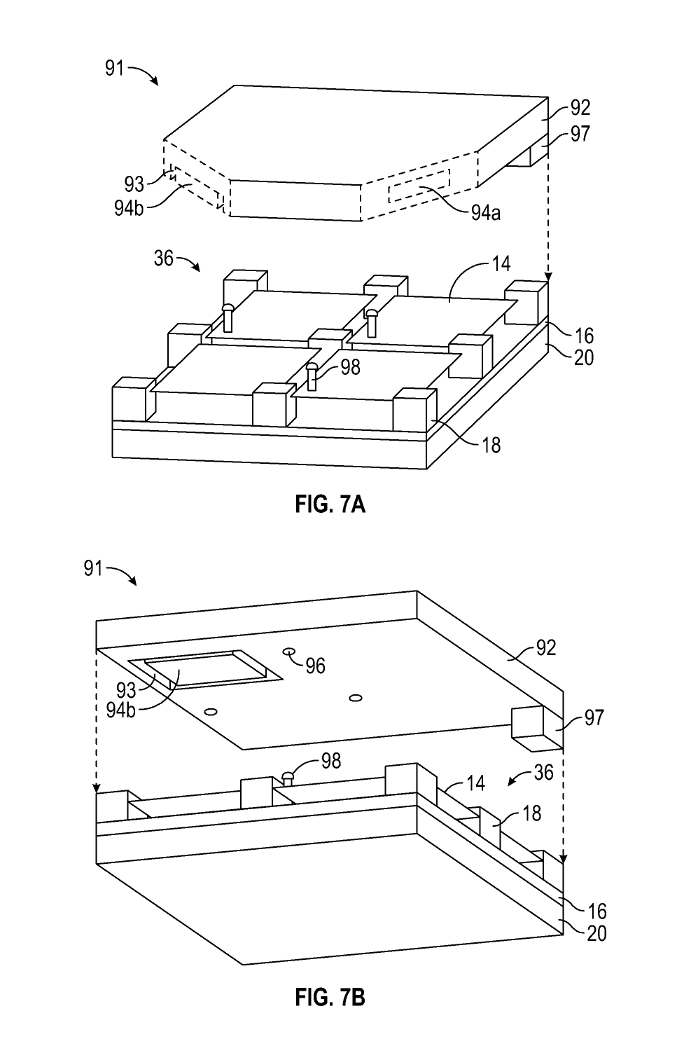

FIGS. 7A and 7B are schematic exploded partial perspective views of a portion of an EMS package 91 including an array 36 of EMS elements and a backplate 92. FIG. 7A is shown with two corners of the backplate 92 cut away to better illustrate certain portions of the backplate 92, while FIG. 7B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 7A and 7B, the backplate 92 can include one or more backplate components 94a and 94b, which can be partially or wholly embedded in the backplate 92. As can be seen in FIG. 7A, backplate component 94a is embedded in the backplate 92. As can be seen in FIGS. 7A and 7B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 7B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 7A and 7B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 7A and 7B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Various implementations of a multi-primary display device can include the EMS array 36. The EMS elements in the array can include one or more IMODs. In some implementations the IMOD can include an analog IMOD (AIMOD). The AIMOD may be configured to selectively reflect multiple primary colors and provide 1 bit per color.

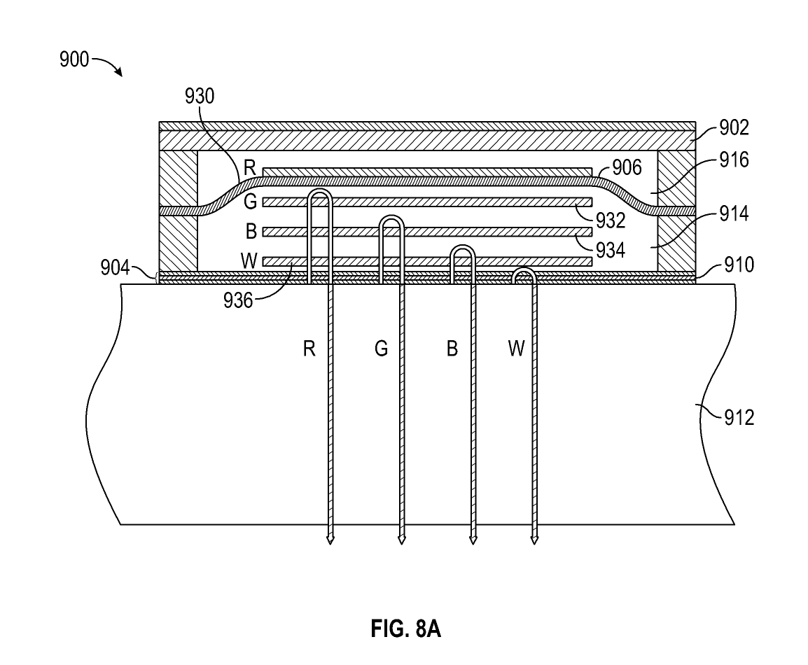

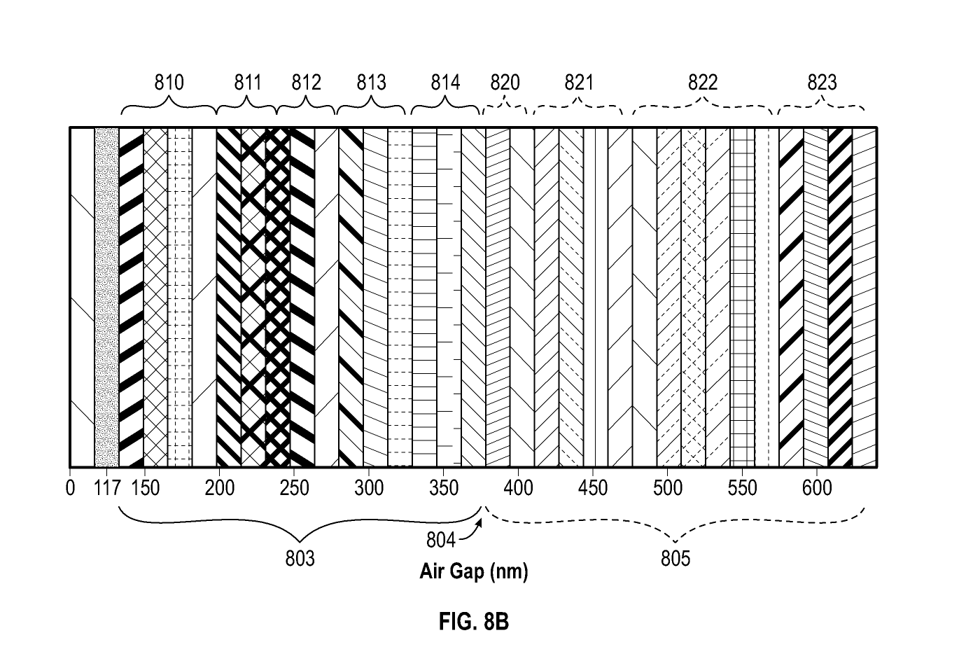

FIG. 8A shows a cross-section of an implementation of an AIMOD. The AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 8A, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (that is, the first electrode 910) can be a layer of material including MoCr with a thickness ranging from approximately 2 nm to 50 nm.

The reflective layer 906 can be actuated toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 8A illustrates that the reflective layer 906 can be moved to various positions 930, 932, 934 and 936 between the first electrode 910 and the second electrode 902.

The AIMOD 900 in FIG. 8A has two structural cavities, a first cavity 914 between the reflective layer 906 and the optical stack 904, and a second cavity 916 between the reflective layer 906 and the second electrode 902. In various implementations, the first cavity 914 and/or the second cavity can include air. The color and/or intensity of light reflected by the AIMOD 900 is determined by the distance between the reflective layer 906 and the absorbing layer (first electrode 910).

The AIMOD 900 can be configured to selectively reflect certain wavelengths of light depending on the configuration of the AIMOD. The distance between the first electrode 910, which in this implementation acts as an absorbing layer and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), that is, light enters the AIMOD 900 through the substrate 912. Depending on the position of the reflective layer 906, different wavelengths of light are reflected back through the substrate 912, which gives the appearance of different colors. These different colors are also referred to as native or primary colors. The number of primary colors produced by the AIMOD 900 can be greater than 4. For example, the number of primary colors produced by the AIMOD 900 can be 5, 6, 8, 10, 15, 18, 33, etc.

A position of the movable layer 906 at a location such that it reflects a certain wavelength or wavelengths can be referred to as a display state of the AIMOD 900. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that and the AIMOD 900 appears “gray” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. In other implementations, the AIMOD 900 can take on different states and selectively reflect other wavelengths of light based on the position of the reflective layer 906, and also based on materials that are used in construction of the AIMOD 900, particularly various layers in the optical stack 904.

FIG. 8B is a color chart that illustrates examples of the various primary colors produced by an implementation of an AIMOD similar to the AIMOD 900 depicted in FIG. 8A. The primary colors in FIG. 8B are illustrated with various types of cross-hatching. The various primary colors are produced as the position of a movable reflector included in the AIMOD is changed, for example, by changing the width of a gap, such as the width of the cavities 914, 916 in the AIMOD 900. The color chart illustrated in FIG. 8B, shows an example of 33 primary colors that can be produced by an implementation of an AIMOD as the gap width is changed from about 0 nm to about 650 nm. As the gap width is varied from about 0 nm to about 650 nm, the AIMOD displays white, when the gap width is about 0 nm; black, when the gap width is about 117 nm; first order primary colors 803; and second order primary colors 805. In implementations of the AIMOD, where the displayed color is a result of optical interference between light reflected from various surfaces of the AIMOD (for example, the optical stack 904 and the reflective layer 906), the first order primary colors 803 can correspond to colors produced by first order interference, while the second order primary colors 805 can correspond to colors produced by second order interference. Without subscribing to any particular theory, a first order primary color having a color level similar to a second order primary color is produced by a gap width that is smaller than a gap width that produces the second order primary color. The first order primary colors include color levels that correspond to different shades of blue at gap widths between about 125 nm and about 200 nm within the region 810; color levels that correspond to different shades of cyan at gap widths between about 200 nm and about 250 nm within the region 811; color levels that correspond to different shades of green at gap widths between about 250 nm and about 275 nm within the region 812; color levels that correspond to different shades of yellow-orange at gap widths between about 275 nm and about 325 nm within the region 813; and color levels that correspond to different shades of red-purple at gap widths between about 325 nm and about 375 nm within the region 813.

The second order primary colors 805 include color levels that correspond to different shades of purple at gap widths between about 375 nm and about 400 nm within the region 820; color levels that correspond to different shades of blue at gap widths between about 400 nm and about 475 nm within the region 821; color levels that correspond to different shades of green at gap widths between about 475 nm and about 550 nm within the region 822; color levels that correspond to different shades of orange-magenta at gap widths between about 550 nm and about 650 nm within the region 823. In various implementations, a boundary 804 between the first order primary colors 803 and second order primary colors 805 can be sharp and/or well defined. In other implementations, the boundary between the first order primary colors 803 and second order primary colors 805 may not be sharp and/or well defined. In various implementations, the first order primary colors 803 and the second order primary colors 805 can include color levels that appear perceptually similar. However, in some implementations, the first order primary colors 803 may be less saturated and/or less bright as compared to the second order primary colors 805.

The multiple primary colors displayed by a display element (for example, AIMOD 900) and the possible color combinations of the multiple primary colors displayed by a display element can represent a color space associated with the display element. A color in the color space associated with the display device can be identified by a color level that represents tone, grayscale, hue, chroma, saturation, brightness, lightness, luminance, correlated color temperature, dominant wavelength, or a coordinate in the color space associated with the display element.

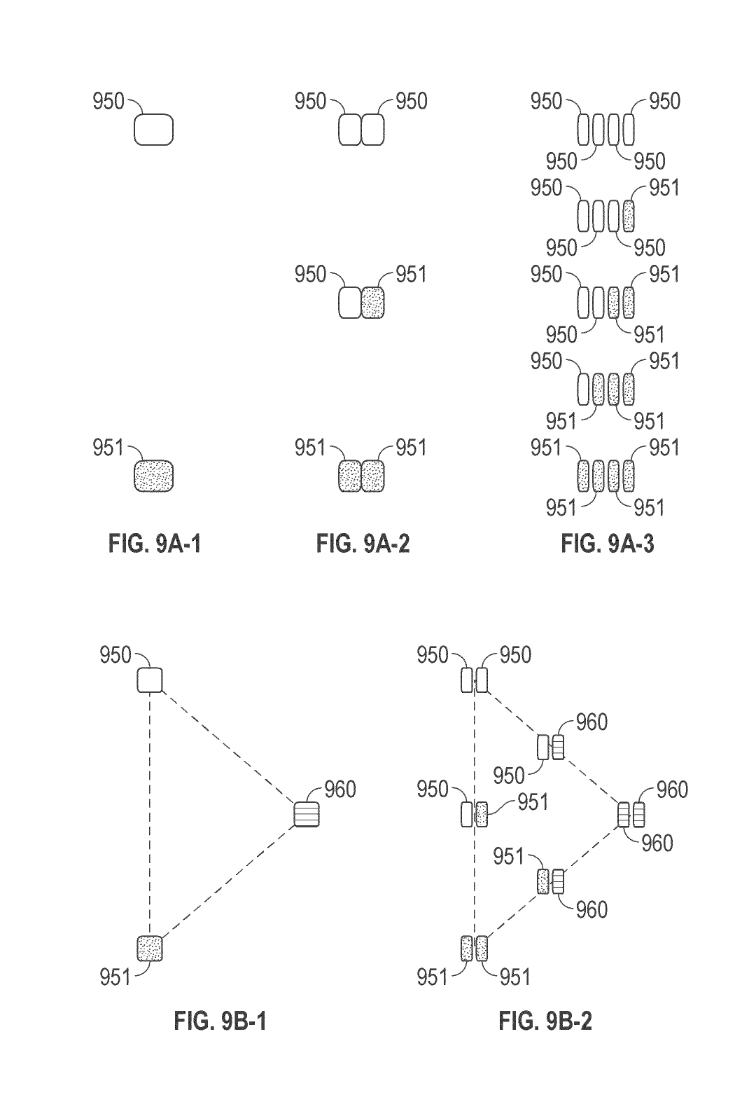

In devices having multiple primary colors with 1 bit per color, such as, for example the AIMOD 900 discussed above, temporal modulation and/or spatial modulation can be used to produce different levels of intensities. FIGS. 9A-1, 9A-2, and 9A-3 illustrate examples of different color levels that can be produced by temporal modulation with a white primary color 950 and a black primary color 951 using one, two or four temporal frames. As illustrated in FIG. 9A-1, only two color levels (for example, white and black color levels) can be produced with a white primary 950 and a black primary 951 using a single temporal frame (no temporal modulation), since the intensity of the primary colors 950 and 951 cannot be changed.

As illustrated in FIG. 9A-2, three color levels (for example, white, gray and black color levels) can be produced by temporal modulation with a white primary 950 and a black primary 951 using two temporal frames. For example, a white color level is produced when both temporal frames are configured to display white color primary 950 and a black color level is produced when both temporal frames are configured to display black color primary 951. Assuming the refresh rate is high enough, a human eye will see only a fused gray tone if one frame is configured to display white primary color 950 and the other frame is configured to display black primary color 951.

As illustrated in FIG. 9A-3, five color levels (for example, white, first gray level, second gray level, third gray level and black) can be produced by temporal modulation with a white primary 950 and a black primary 951 using four temporal frames. For example, a white color level is produced when all four temporal frames are configured to display white color primary 950 and a black color level is produced when all four temporal frames are configured to display black color primary 951. Assuming the refresh rate is high enough, a human eye will see a first gray level if three frames are configured to display white primary color 950 and the fourth frame is configured to display black primary color 951; a second gray level if two frames are configured to display white primary color 950 and the other two frames are configured to display black primary color 951; and a third gray level if one frame is configured to display white primary color 950 and the other three frames are configured to display black primary color 951.

FIGS. 9B-1 and 9B-2 illustrate examples of different color levels that can be produced by temporal modulation with a white primary color 950, a black primary color 951 and a non-black and non-white (e.g., red) primary color 960 using one or two temporal frames. As illustrated in FIG. 9B-1, three color levels (for example, white, black and red color levels) can be produced with a white primary 950, a black primary 951 and a red color primary 960 using a single temporal frame without temporal modulation.

As illustrated in FIG. 9B-2, six color levels (for example, white, gray, black, red, a more saturated red and a less saturated red) can be produced by temporal modulation with a white primary 950, a black primary 951 and a red color primary 960 using two temporal frames. For example, a white color level is produced when both temporal frames are configured to display white color primary 950; a black color level is produced when both temporal frames are configured to display black color primary 951; and a red color level is produced when both temporal frames are configured to display red color primary 960. Assuming the refresh rate of the display device is high enough, a human eye will see a gray color level if one frame is configured to display white primary color 950 and the other frame is configured to display black primary color 951; a bright red color level if one frame is configured to display white primary color 950 and the other frame is configured to display red primary color 960; a dark red color level if one frame is configured to display black primary color 951 and the other frame is configured to display red primary color 960; and a saturated red color level if both frames are configured to display red primary color 960. More colors can be produced with more temporal frames and by adding more primary colors as discussed below.

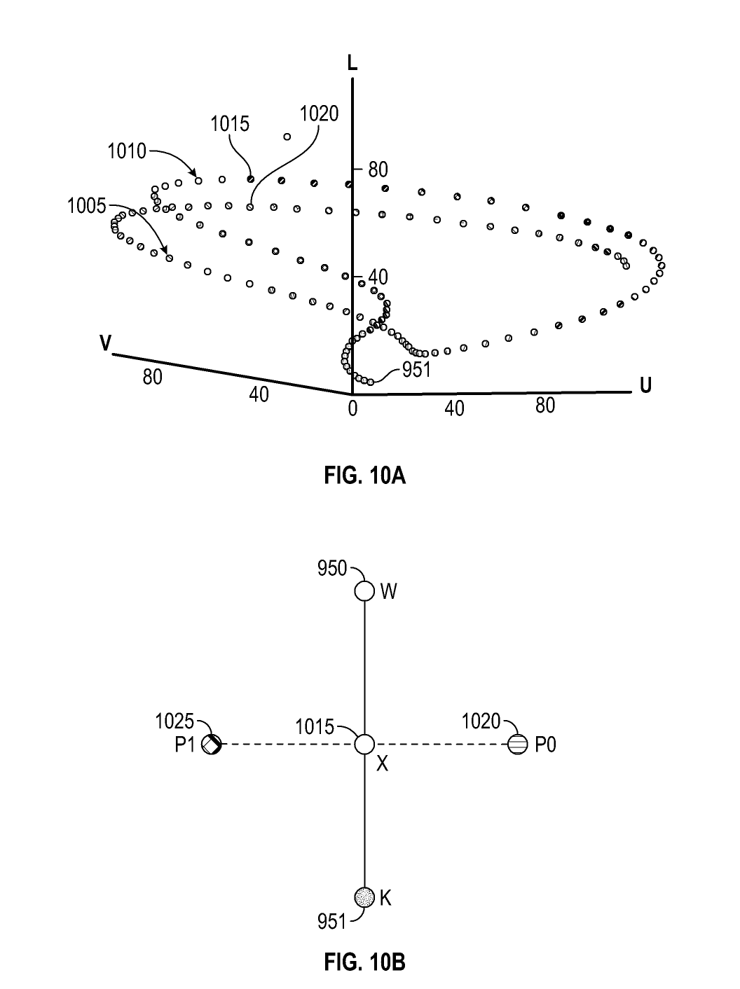

FIG. 10A shows an example of a set of 128 native primary colors produced by a multi-primary display device in the International Commission on Illumination (CIE) Luv color space. The 128 primary colors includes a black color primary 951; a set of first order primary colors 1005; and a second set of second order primary colors 1010. It is noted from FIG. 10A, the first order primary colors 1005 and the second order primary colors 1010 have color levels (e.g., shades or hues) that are perceptually similar. However, in this example, the first order primary colors 1005 are less saturated (or less bright) as compared to the second order primary colors 1010. For example, the first order primary color 1020 has a color level (e.g., shade, tone or hue) that appears perceptually similar to the color level (e.g., shade, tone or hue) of the second order primary color 1015. However, the second order primary color 1015 is brighter as compared to the first order primary color 1020. It is also observed from FIG. 10A, that the first order primary colors 1005 and the second order primary colors 1010 are spirally arranged about the lightness (L) axis of the Luv color space. Image data having input color values in a 3-D color space (e.g., RGB values, YUV values, L*a*b* values, sRGB values, etc.) can be reproduced on a display device including a display element having multiple primary colors by several (or even many) different combinations of all or a sub-set of the 128 primary colors.

FIG. 10B illustrates an example of producing a gray (X) color level 1015 by combining different primary colors and using temporal modulation with two temporal frames. As illustrated in FIG. 10B, a gray (X) color level 1015 may be produced by configuring a first temporal frame to display white (W) primary color 950 and a second temporal frame to display black (K) primary color 951, as discussed above with reference to FIGS. 9A1-9A3 and 9B1-9B2. Alternatively, the gray (X) color level 1015 may be produced by configuring a first temporal frame to display a first (P0) primary color 1020 (for example, a red primary color) and a second temporal frame to display a second (P1) primary color 1025 (for example, a blue primary color). A color may be closely reproduced by adding more primary colors and/or additional frames by temporal modulation. In various implementations, this can also be referred to as temporal dither.

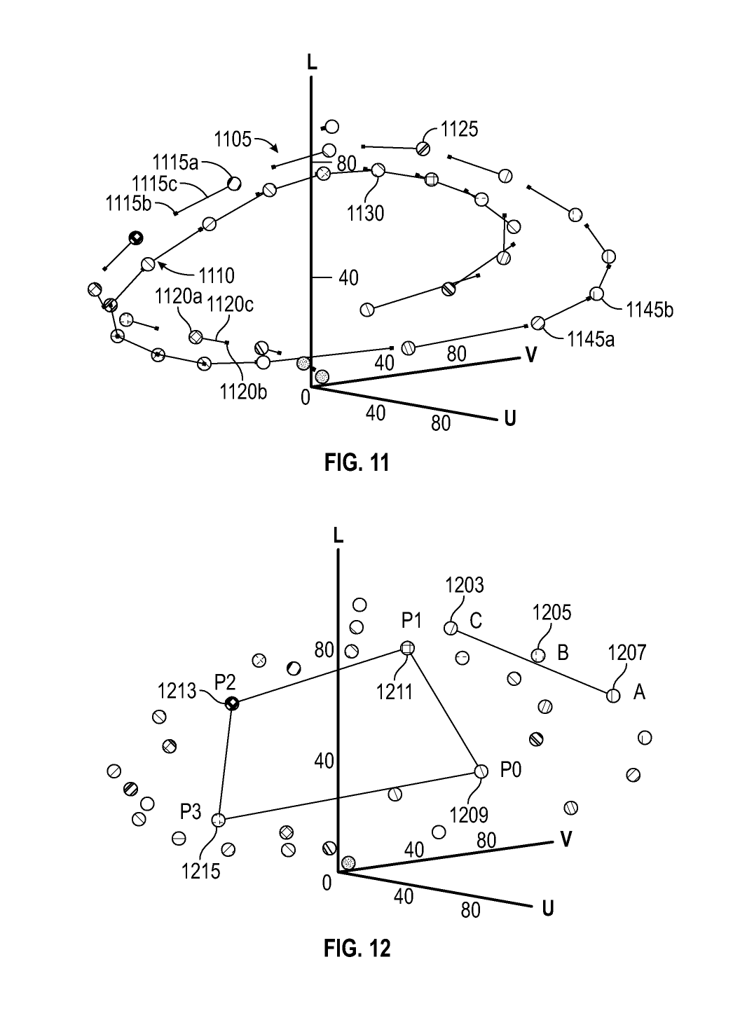

Display devices including EMS based display elements, such as, for example, an AIMOD can be susceptible to angular metamerism, when colors that appear the same in one viewing direction look different in another viewing angle. Angular metamerism can be disadvantageous in color rendering on display devices including multi-primary display elements that produce multiple primary colors (for example, more than three primary colors), as two colors that are metameric (or perceptually similar) to each other along one viewing direction may become visually distinct along another viewing direction. Furthermore, angular metamerism can produce additional artifacts, such as contouring and banding. Angular metamerism is explained in greater detail below with reference to FIG. 11.

FIG. 11 illustrates an example of the color shift that may occur when a set of primary colors (for example, the 128 primary colors depicted in FIG. 10A) produced by a multi-primary display element is viewed along two different directions. Similar to FIG. 10A, FIG. 11 illustrates a set of first order primary colors represented by the inner circular region 1110 and a set of second order primary colors represented by the outer circular region 1105. Although, the first order primary colors 1110 and the second order primary colors 1105 include color levels that are perceptually similar, the second order primary colors 1105 are brighter or more saturated as compared to the first order primary colors 1110. For example, the first order primary color 1130 appears perceptually similar to the second order primary color 1125. However, the second order primary color 1125 is brighter as compared to the first order primary color 1130.

In FIG. 11, the circles (for example, circles 1115a, 1120a, 1125 and 1130) represent the color level of the first and second order primary colors 1105 and 1110 produced by a multi-primary display element (for example, the AIMOD 900) when the display element is viewed along a direction normal to a surface of the display element (for example, substrate 912 of the AIMOD 900 or the electrode 902 of the AIMOD 900). Still referring to FIG. 11, the squares (for example, squares 1115b and 1120b) represent the color level of the first and second order primary colors 1105 and 1110 when the display element is viewed along a direction that is at about 10 degrees with respect to the normal to the surface of the display element. The value of 10 degrees is used to illustrate an example of angular metamerism. When a display device is in use, the angle can be between zero degrees and 90 degrees depending on how the device is oriented relative to a user's eyes. The length of each line that connects each circle to each square (for example, lines 1115c and 1120c) represents the difference in the color level (or an amount of color shift) when a primary color is viewed along the normal to a surface of the display element and at 10 degrees with respect to the normal. It is noted from FIG. 11, that different primary colors shift by different amounts when the viewing angle changes from normal to about 10 degrees with respect to the normal. This difference in the amounts of color shift can cause some primary colors that are perceived to have a first color level (e.g. shade, hue or tone) along a first viewing direction to be perceived as having a second color level different from the first color level along a second viewing direction. For example, primary color 1145a has a first color level that appears red along a viewing direction that is normal to a surface of the display element. However, when the viewing direction is about 10 degrees with respect to the normal, the primary color 1145a would shift to the right and would have a second color level 1145b that appears orange. Thus, angular metamerism can affect the visual quality of images displayed by the display device.

It is also observed from FIG. 11, that the color level of some primary colors from the first order primary colors 1110 are shifted along a first direction when the viewing angle changes from normal to 10 degrees with respect to the normal, while the color level of some primary colors from the second order primary colors 1105 are shifted along a second direction when the viewing angle changes from normal to 10 degrees with respect to the normal. For example, the color level of primary color 1115a from the second order primary colors 1105 is shifted to the left when the viewing angle changes from normal to 10 degrees with respect to the normal, while the color level of primary color 1120a from the first order primary colors 1110 is shifted to the right when the viewing angle changes from normal to 10 degrees with respect to the normal. Thus, a combination color when produced by combining primary colors from the first and second order primary colors may have a different color shift behavior than when produced by combining primary colors from the same order.

In order to reduce angular metamerism, it may be advantageous to reduce the number of combination colors that can be produced by temporal modulation by constraining the ways in which the various primary colors are combined. For example, it is noted from FIG. 11 that the color shift for black and white primary colors is lesser than the color shift for the primary colors in either the first order primary colors 1110 or the second order primary colors 1105. Thus, combination colors that are produced by temporal modulation using black and white primary colors may exhibit less color shift as the viewing angle changes. Furthermore, since it may be difficult to predict the direction of color shift for combination colors produced by temporal modulation using primary colors from different orders, it may be advantageous to use primary colors from the same order (for example, either first order or the second order) when producing combination colors by temporal modulation so that the color shift behavior is more predictable. The discrete set of color combinations which is a subset of less than all possible color combinations that can reduce angular metamerism is referred to as a constrained color palette. The constrained color palette can be used in temporal (and/or spatial) modulation schemes and can provide good color reproduction of input images with less angular metamerism than with the full color palette of all possible color combinations.

FIG. 12 illustrates an example of different color combinations of primary colors that can be excluded from a constrained color palette in order to reduce angular metamerism. In FIG. 12, a combination color produced by temporal modulation using primary colors 1203 (C) and 1207 (A) would generate a combination color that is perceptually similar to the primary color 1205 (B). Thus, such a combination can be excluded from the constrained color palette. Still referring to FIG. 12, a combination color produced by temporal modulation using primary colors 1209 (P0), 1211 (P1), 1213 (P2) and 1215 (P3) that have different hues would produce a gray color level, since the different hues of the primary colors 1209 (P0), 1211 (P1), 1213 (P2) and 1215 (P3) would cancel each other. A combination of black and white primary colors can yield a similar gray color level. Since, angular metamerism is lower for black and white primary colors, a gray level produced by combination of the non-black and non-white primary colors 1209, 1211, 1213 and 1215 can be excluded from the constrained color palette as well.

The above described examples of ways to select color combinations to be included in the constrained color palette can be summarized as follows:
(i) Select combination colors that are produced by using only black and/or white primary colors;
(ii) Select combination colors that are produced by primary colors having color levels (e.g., shades, hues or tones) that are within a neighborhood of each other. In other words, exclude combination colors that are produced by primary colors have complementary or very different color levels.
(iii) Select combination colors that are produced by the black primary color and one or more non-black and non-white primary colors that are within a neighborhood of each other.
(iv) Select combination colors that are produced by white primary color and one or more non-black and non-white primary colors that are within a neighborhood of each other.
(v) Select combination colors that are produced by white primary color, black primary color, and one or more non-black and non-white primary colors that are within a neighborhood of each other.

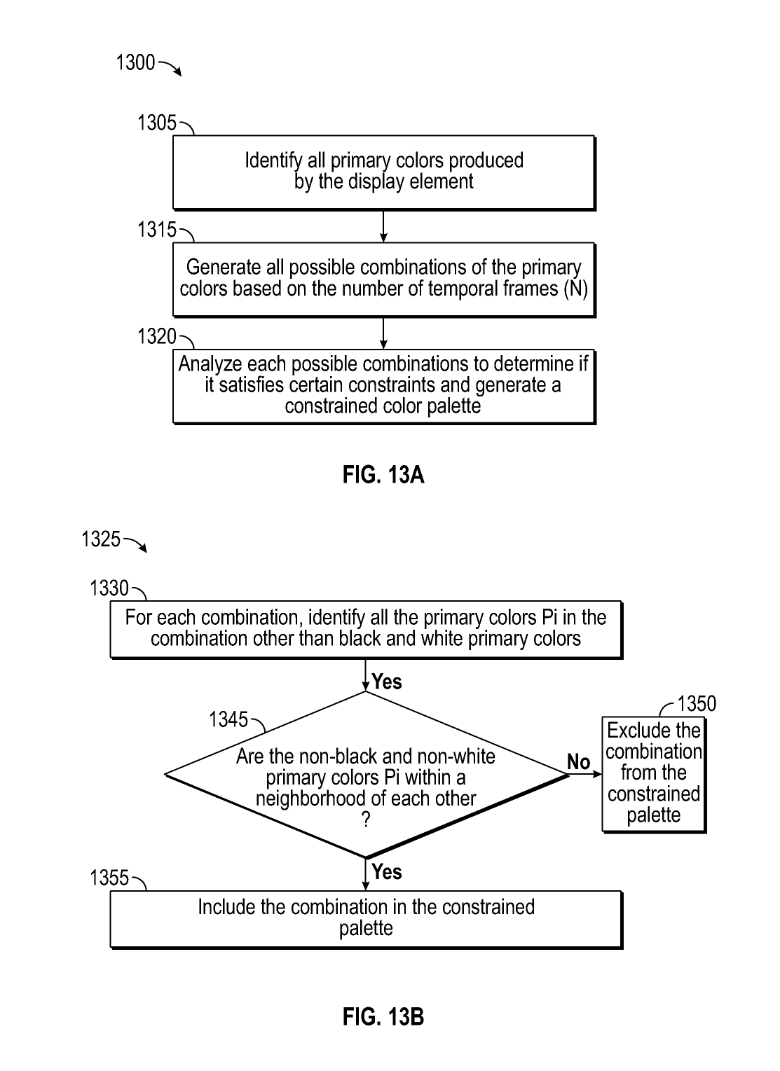

FIG. 13A is a flow chart that describes an implementation of a method 1300 of generating a constrained color palette by excluding combinations of different primary colors that do not satisfy certain constraints. The method 1300 includes at block 1305 identifying all primary colors produced by a multi-primary display element (for example AIMOD 900) included in a display device. For example, in various implementations, the display element can produce M primary colors P₀, P₁, P₂, . . . , P_{M-1}, where M can have a value greater than 3. For example, M can have a value equal to 4, 5, 6, 8, 10, 33, 128, etc. For an implementation of the AIMOD display element 900, the M primary colors can represent the colors produced by the AIMOD for different widths of the cavity 914 between the reflector layer 906 and optical stack including layers 904 and 910. In such a display element, the primary colors P₀, P₁, P₂, . . . , P_{M-1} can be arranged and indexed in the order of increasing widths of the cavity 914 similar to FIG. 8A. The different primary colors can be classified into first and second order primary colors. In some implementations of the display element, the first order primary colors can range from black to dark magenta, and the second order primary colors can range from purple to light magenta. In various implementations of the display element, if two primary colors have similar hues, then the primary color produced by a smaller gap width is classified as first order and the primary color produced by a smaller gap width is classified as second order.

The method 1300 further includes generating possible combinations of the primary colors based on the number (N) of temporal frames as shown in block 1315. In various implementations of the method 1300, all (or substantially all) of the possible combinations of primary colors are generated. Each of the generated combinations is produced by selecting N primary colors Q₀, Q₁, Q₂, . . . , Q_{N-1} from the set of primary colors P₀, P₁, P₂, . . . , P_{M-1}. The index N denotes the number of available frames for temporal modulation. In various implementations, N is smaller than M and in some implementations may be much smaller than M. For example, in various implementations, N can have values 1, 2, 4, 6 or 8. In some implementations, a primary color, Pᵢ, in the primary set is allowed to be selected multiple times to generate a combination color. Thus, each of N selected primary colors Q₀, Q₁, Q₂, . . . , Q_{N-1} does not need to be a unique primary color. For example, Q₀ and Q₁ can be the same primary color. In various implementations, the N primary colors are within a neighborhood of each other as discussed above. In some implementations, some of the N primary colors can be from one interferometric order and some others of the of the N primary colors can be from a different interferometric order such that the N primary colors are within a neighborhood of each other. In various implementations, the N primary colors can be from the same interferometric order. For example, in some implementations, the N primary colors can belong to the first interferometric order. As another example, in some implementations, the N primary colors can belong to the second interferometric order. A constrained color palette is generated by analyzing each possible combination to determine if it satisfies certain conditions, as shown in block 1320. In view of the above discussion, the constrained color palette can be considered to be generated by analyzing the properties of the various primary colors.

FIG. 13B is a flow chart that describes an implementation of a method 1325 of analyzing possible combinations of the different primary colors to generate a constrained color palette. The method 1325 includes identifying all the primary colors in each combination that are not black or white primary colors, as shown in block 1330. For each of those color combinations that are produced by primary colors, if the non-black and non-white primary colors are not within a neighborhood of each other (in the color space associated with the display device), then that color combination is excluded from the constrained color palette as illustrated by decision block 1345 and the block 1350. The size of the neighborhood can be represented by a neighbor value D. The neighbor value D can be selected such that primary colors that are within a neighborhood of each other have color levels (e.g., shade, hue or tone) that are sufficiently close to each other such that primary colors within a neighborhood of each other are not complementary colors or primary colors with very different hues. In some implementations, a size of the neighborhood can be set by a difference in index sequence numbers. For example, in a color combination two non-black and non-white primary colors C_{I} and C_{J} having index sequence values I and J can be considered to be within a neighborhood of each other if the difference between the index sequence value J and the sequence value I is equal to or less than the neighbor value D. In various implementations, the neighbor value D can be between 0 and 4. In various implementations, a size of the neighborhood can be set by a distance in a color space, e.g., the Luv color space, the device color space, etc. A constrained color palette is generated by including those combination colors that are not excluded in block 1350, as shown in block 1355.

Temporal modulation using a combination of primary colors that is included in the constrained color palette can be used for displaying images, while a combination of primary colors not included in the constrained color palette is not used while displaying images. The constrained color palette can be pre-generated by a processor under the control of a hardware device configured with executable instructions to execute the methods 1300 and/or 1325. The pre-generated constrained color palette can subsequently be included in a display device for use while displaying images (e.g., by storing the constrained color palette in a non-transitory memory in the device). Pre-generating the constrained color palette can increase the speed of displaying images by temporal modulation using the constrained color palette. In various implementations, in addition to restricting the combination of various primary colors that are displayed, a diffuser can be provided to the display device to further reduce angular metamerism. In various implementations, in addition to restricting the combination of various primary colors that are displayed, other methods such as error diffusion and spatial dithering can be used to display high bit-depth images that are visually pleasing.

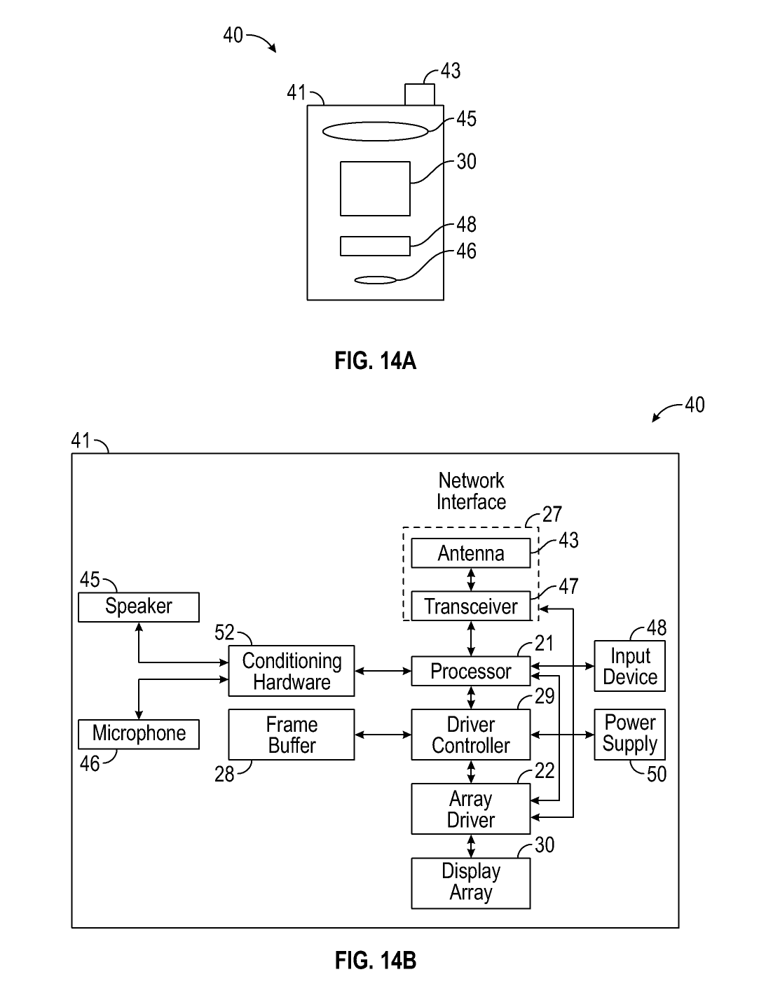

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time. For example, in some implementations using a large number of primary colors (e.g., greater than 8 primary colors) and several temporal frames (e.g., greater than 3), the number of possible color combinations in the full color palette can be very large (e.g., hundreds, thousands, or more possible colors) and a physical computing device may be necessary to perform the methods for generating a constrained color palette from such a large number of possible colors. Accordingly, various implementations of the methods 1300 and 1325 can be performed by a hardware processor included in the display device (for example, the processor 21, the driver controller 29, and/or the array driver 22 described below with reference to the display device of FIGS. 14A and 14B). To perform the methods 1300 and 1325, the processor can execute a set of instructions stored in non-transitory computer storage. The processor can access a computer-readable medium that stores the constrained color palette. The color palette may be stored as a look-up table (LUT). Various other implementations of the methods 1300 and 1325 can be performed by a hardware processor included in a computing device separate from the display device. In such implementations, the outputs of the methods 1300 and 1325 can be stored in non-transitory computer storage and provided for use in a display device.

FIGS. 14A and 14B are system block diagrams illustrating a display device 40 that includes a plurality of IMOD display elements including but not limited to implementations similar to AIMOD 900. The display device 40 can be configured to use temporal (and/or spatial) modulations schemes that utilize the constrained color palette disclosed herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). The driver controller 29 and/or the array driver 22 can be an AIMOD controller or driver. In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described methods for generating a constrained color palette may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A computer-implemented method to generate a color palette for temporal modulation in digital imaging, the method comprising:
under control of a hardware computing device:
identifying a set of M primary colors that can be produced by a display element, the set of primary colors including black and white, wherein the set includes M minus 2 non-white and non-black color primaries, wherein M is at least 6;
generating the color palette, wherein the color palette includes color combinations produced by selecting N primary colors from the identified set of M primary colors, wherein N represents a number of sub-frames for temporal modulation and N is less than M;
generating a constrained color palette from the color palette, wherein the generating includes:
for each color combination in the color palette:
adding a respective color combination to the constrained color palette if
each non-white and non-black color primary in the respective color combination, is within a neighborhood of each other non-white and non-black color primary in the respective color combination; and
providing the constrained color palette for use in a temporal modulation scheme.

2. The method of claim 1, wherein all color combinations including only black and white are added to the constrained color palette.

3. The method of claim 1, wherein colors in the color palette are indexed by a sequence value, and for two non-white and non-black color primaries C_{I} and C_{J} in the respective color combination with index sequence values I and J, the two non-white and non-black color primaries C_{I} and C_{J} are within the neighborhood of each other if the difference between I and J is less than or equal to a neighbor value D, where the neighbor value D is a size of the neighborhood around the non-white and non-black color primary C_{I}.

4. The method of claim 2, wherein the neighbor value D has a value between 0 and 4.

5. The method of claim 1, wherein two non-white and non-black color primaries in the respective color combination are within the neighborhood of each other if a distance between the two non-white and non-black color primaries in a color space is less than a threshold distance in the color space.

6. The method of claim 1, wherein the set of primary colors includes at least four (4) primary colors.

7. The method of claim 1, wherein the display element includes an interferometric modulator, and the N primary colors are from at least one interferometric order

8. The method of claim 7, wherein the N primary colors are from the same interferometric order.

9. A device comprising:
a display configured to display an image data, the display including a display element;
a processor that is configured to communicate with the display, the processor being configured to process image data; and
a non-transitory memory device that is configured to communicate with the processor,
wherein the device is configured to display the image data with a temporal modulation scheme using the constrained color palette generated by the method of claim 1.

10. The device of claim 9, wherein the display is a reflective display device.

11. The device of claim 9, wherein the display element includes a movable mirror.

12. The device of claim 11, wherein the display element is configured to display a color in a color space associated with the display, the displayed color depending on a position of the movable mirror.

13. The device of claim 9, further comprising a driver circuit configured to send at least one signal to the display.

14. The device of claim 13, further comprising a controller configured to send at least a portion of the image data to the driver circuit.

15. The device of claim 9, further comprising an image source module configured to send the image data to the processor.

16. The device of claim 15, wherein the image source module includes at least one of a receiver, transceiver, and transmitter.

17. The device of claim 9, further comprising an input device configured to receive input data and to communicate the input data to the processor.

18. A non-transitory computer storage medium comprising instructions that when executed by a processor cause the processor to perform a method to generate a color palette for temporal modulation in digital imaging, the method comprising:
identifying a set of M primary colors that can be produced by a display element, the set of primary colors including black and white, wherein the set includes M minus 2 non-black and non-white color primaries, wherein M is at least 6;
generating the color palette, wherein the color palette includes color combinations produced by selecting N primary colors from the identified set of M primary colors, wherein N represents a number of sub-frames for temporal modulation and N is less than M;
generating a constrained color palette from the color palette, wherein the generating includes:
for each color combination in the color palette:
adding a respective color combination to the constrained color palette if:
each non-black and non-white color primary in the respective color combination, is within a neighborhood of each other non-black and non-white color primary in the respective color combination; and
providing the constrained color palette for use in a temporal modulation scheme.

19. The method of claim 18, wherein all color combinations including only black and white are added to the constrained color palette.

20. The non-transitory computer storage medium of claim 18, wherein colors in the color palette are indexed by a sequence value, and for two non-black and non-white color primaries C_{I} and C_{J} in the respective color combination with index sequence values I and J, the two non-black and non-white color primaries C_{I} and C_{J} are within the neighborhood of each other if the difference between I and J is less than or equal to a neighbor value D, where the neighbor value D is a size of a neighborhood around the non-black and non-white color primary C_{I}.

21. The non-transitory computer storage medium of claim 20, wherein the neighbor value D has a value between 0 and 4.

22. The non-transitory computer storage medium of claim 18, wherein two non-black and non-white color primaries in the respective color combination are within the neighborhood of each other if a distance between the two non-black and non-white color primaries in a color space is less than a threshold distance in the color space.

23. The non-transitory computer storage medium of claim 18, wherein the set of primary colors includes at least four (4) primary colors.
